(19) United States
(12) Patent Application Publication
(10) Pub. No.: US 2022/0258309 A1
(43) Pub. Date: Aug. 18, 2022

(54) Spindle Area Tube Removal and Installation Tool

(71) Applicants: DANIEL LYNCH, New Bern, NC (US); TIMOTHY WETHERINGTON, Havelock, NC (US)

(72) Inventors: DANIEL LYNCH, New Bern, NC (US); TIMOTHY WETHERINGTON, Havelock, NC (US)

(73) Assignee: United States of America as represented by the Secretary of the Navy, Patuxent River, MD (US)

(21) Appl. No.: 17/174,523

(22) Filed: Feb. 12, 2021

(51) Int. Cl. B25B 13/48

(52) U.S. Cl. CPC B25B 13/481; B25B 17/00

(57) ABSTRACT

The spindle area tube removal and installation tool includes an outer tube assembly; an inner tube assembly disposed within the outer tube assembly, the inner tube assembly having a first end and a second end; a handle assembly attached to the first end of inner tube assembly such that when the handle assembly is rotated the inner tube assembly rotates; a head assembly for gripping clamps within the spindle area; a gear assembly communicating with the head assembly, the gear assembly attached to the second end of the inner tube assembly such that when the inner tube assembly rotates the gear assembly provides a ninety degree power transfer to the head assembly, such that the head assembly rotates the clamps within the spindle area 360 degrees, allowing removal of the spindle area tube.

### STATEMENT OF GOVERNMENT INTEREST

The invention described herein may be manufactured and used by or for the Government of the United States of America for governmental purposes without payment of any royalties thereon or therefor.

### BACKGROUND

The spindle area of an aircraft can be defined, but without limitation, as the outboard of a wing which houses an aircraft engine, gear boxes, hub assembly, and nacelle houses. In the spindle area of an aircraft, particularly, a V-22 Osprey, there are tubes, two of which are for aircraft hydraulic systems and one of is for the emergency lubrication system. Often these tubes need to be removed and replaced. For years, in order to remove and replace tubes that were in the spindle area of a V-22 required removing the tilt axis gearbox. This process is difficult, time consuming, and often caused damage to spindle area. Additionally, this process sometimes resulted in creating the need for other maintenance such as resurfacing, stud replacement, or replacement of the tilt axis gearbox. Furthermore, this process required at least three people. Moreover, the average time to perform this process was between 162 hours and 190 hours. Thus, there is a need for an apparatus or process that allows easier and quicker removal and replacement of the tubes.

### SUMMARY

The present invention is directed to a spindle area tube removal and installation tool with the needs enumerated above and below.

The present invention is directed to a spindle area tube removal and installation tool comprising of an outer tube assembly; an inner tube assembly disposed within the outer tube assembly, the inner tube assembly having a first end and a second end; a handle assembly attached to the first end of inner tube assembly such that when the handle assembly is rotated the inner tube assembly rotates; a head assembly for gripping clamps within the spindle area; a gear assembly communicating with the head assembly, the gear assembly attached to the second end of the inner tube assembly such that when the inner tube assembly rotates the gear assembly provides a ninety degree power transfer to the head assembly, such that the head assembly rotates the clamps within the spindle area 360 degrees, allowing removal of the spindle area tube.

It is a feature of the present invention to provide a tool that is easy to use and quickly removes tubes in the V-22 spindle area in typically less than four hours.

It is a feature of the present invention to provide a tool that removes and installs tubes in the V-22 spindle area that does not require removal of the tilt axis gear box.

It is a feature of the present invention to provide a tool that saves time and money and minimizes damage to any of the surrounding components.

### DRAWINGS

These and other features, aspects and advantages of the present invention will become better understood with reference to the following description and appended claims, and accompanying drawings wherein:

FIG. 1 is a side view of the spindle area tube removal and installation tool;

FIG. 2 is a view of the composite outer tube assembly that houses the inner tube assembly;

FIG. 3 is a view of the inner composite tube, which turns within the outer tube assembly;

FIG. 4 is a view of the handle assembly, with a locking feature that rotates, connected to inner tube;

FIG. 5 is various views of the head assembly, used to rotate the clamps, connected to gear assembly;

FIG. 6 is various views of the gear assemble, which provides the 90 degree angle that joins inner tube and head assembly;

FIG. 7 is as view of the of the inner tube assembly first end;

FIG. 8 is a view of the inner tubes second end;

FIG. 9 is a view of the clamps within the spindle area that the tool rotates to unlock;

FIG. 10 is a view of the spindle area with no markers;

FIG. 11 is a view of the spindle area which identifies the lines that can be removed with tool; and,

FIG. 12 is an overview of the tool with markers identifying individual parts.

### DESCRIPTION

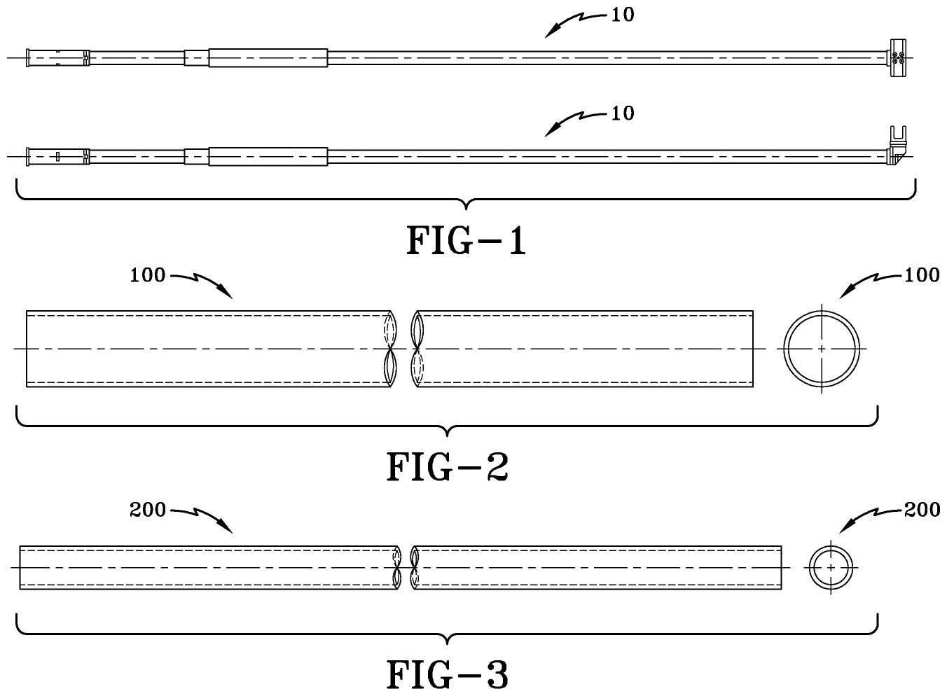

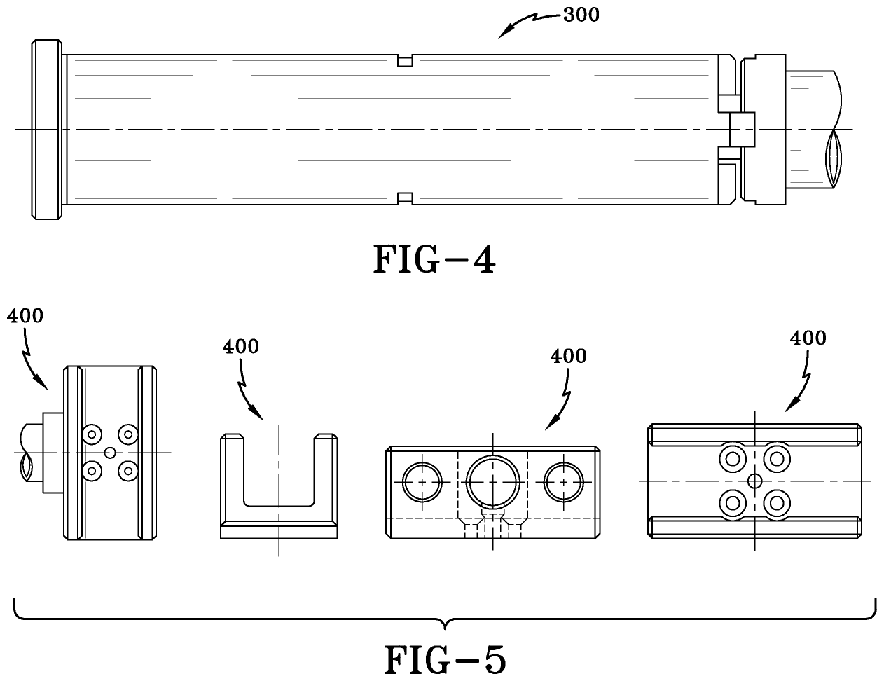

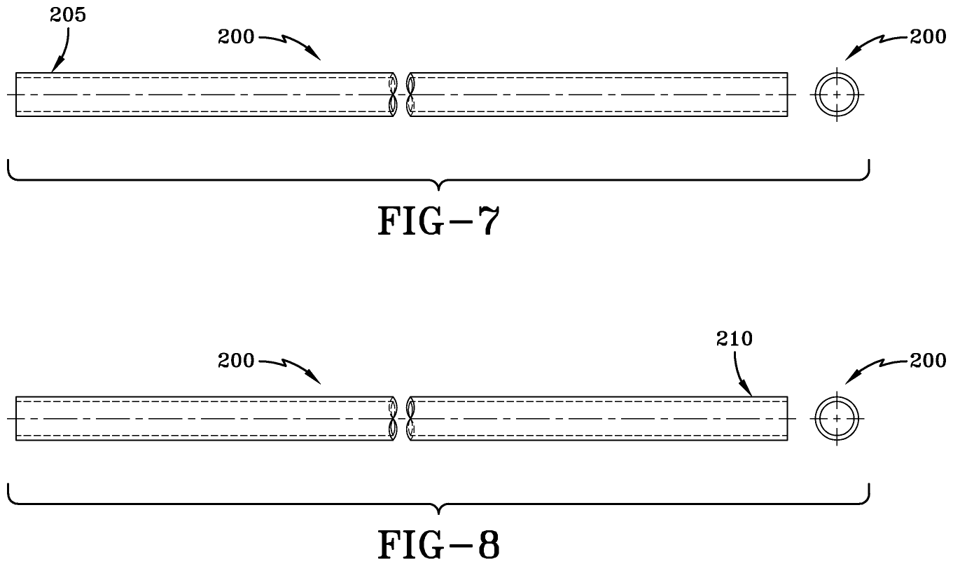

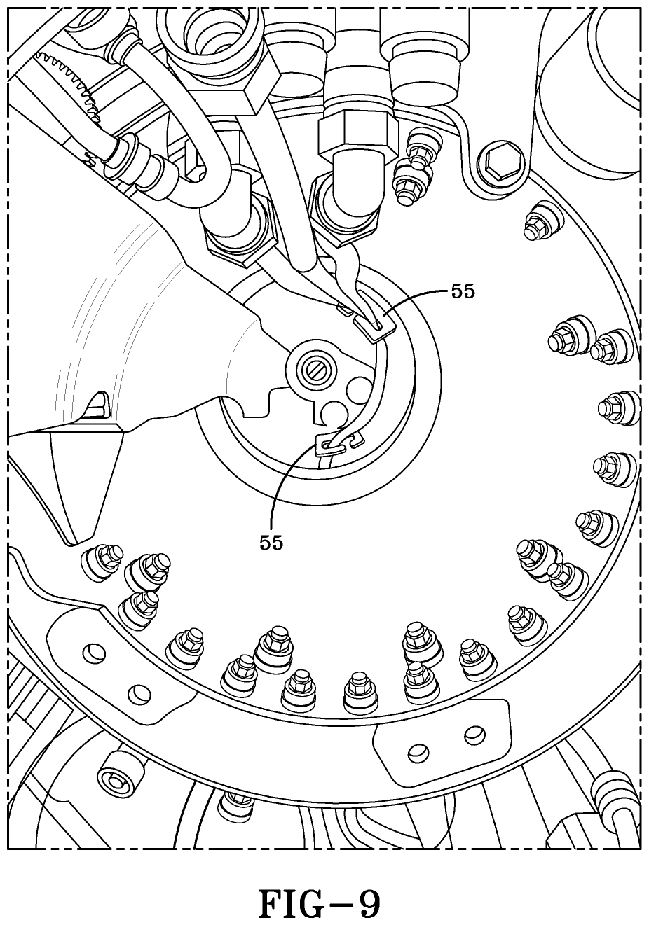

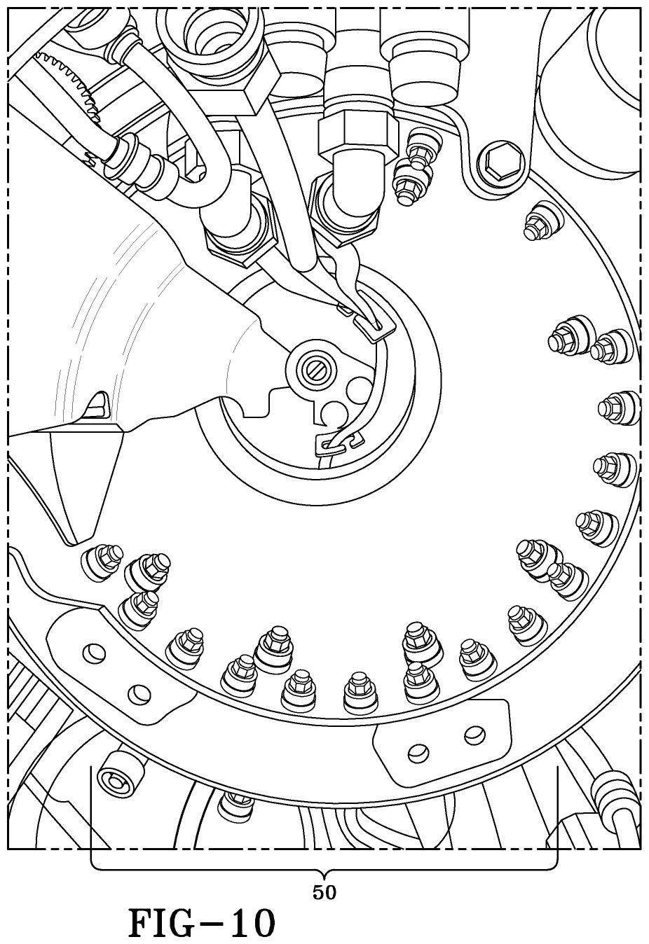

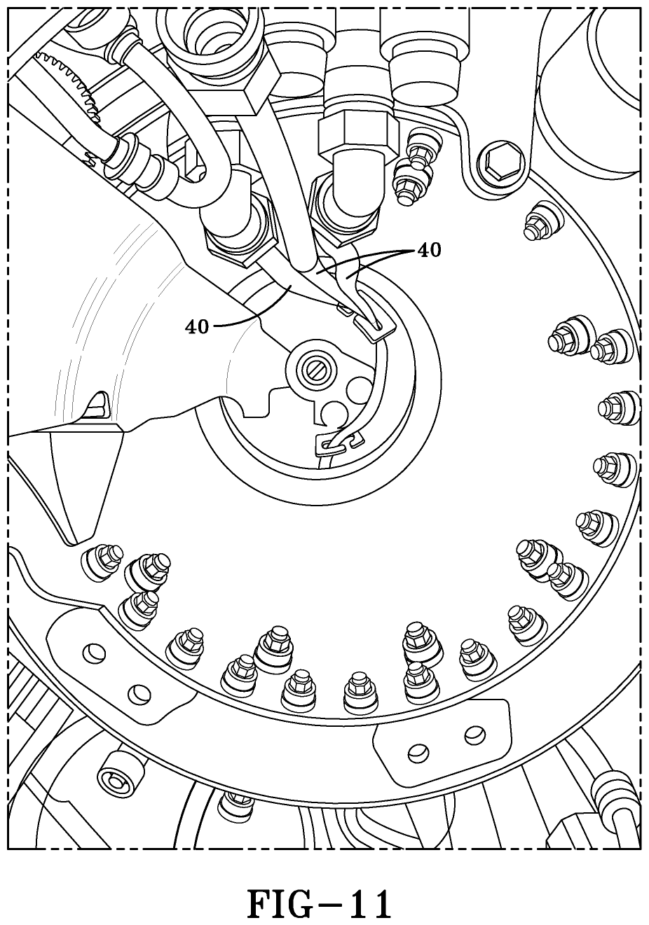

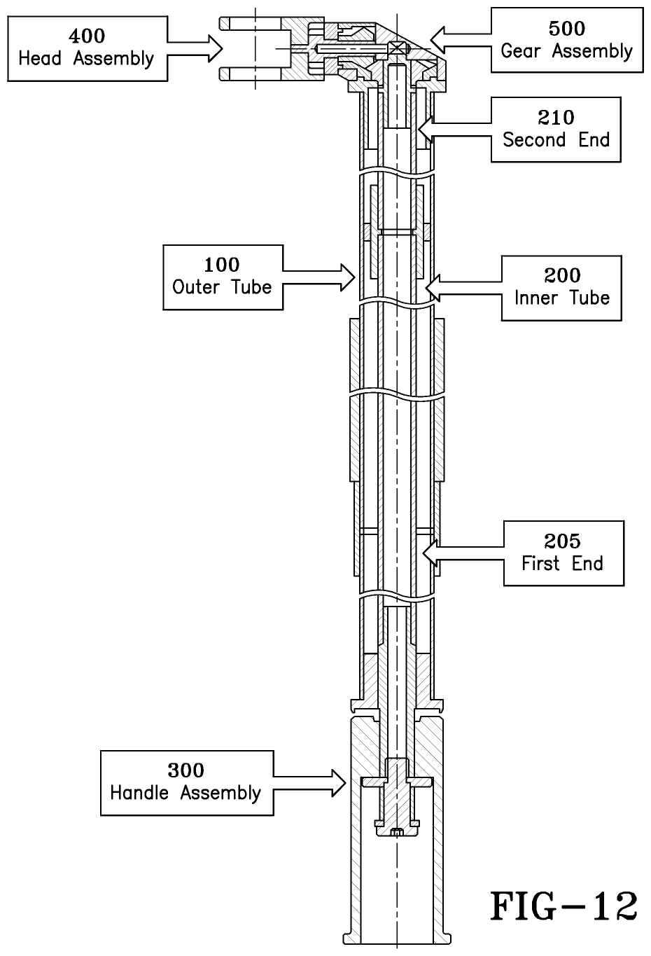

The preferred embodiments of the present invention are illustrated by way of example below and in FIGS. 1-12. As seen in FIG. 1-12, the spindle area tube removal and installation tool 10 includes an outer tube assembly 100, an inner tube assembly 200, a handle assembly 300, a head assembly 400, and a gear assembly 500. The inner tube assembly 200 is disposed within the outer tube assembly 100. The inner tube assembly 200 has a first end 205 and a second end 210. The handle assembly 300 is attached to the first end 205 of inner tube assembly 200 such that when the handle assembly 300 is rotated, the inner tube assembly 200 rotates. The head assembly 400 is for gripping clamps 55 that secure the spindle area tubes 40 that are disposed within the spindle area 50. The gear assembly 500 communicates with the head assembly 400, while the gear assembly 500 is attached to the second end 210 of the inner tube assembly 200, such that when the inner tube assembly 200 rotates, the gear assembly 500 provides a ninety degree power transfer to the head assembly 400, such that the head assembly 400 rotates the clamps 55 within the spindle area 50 three hundred and sixty (360) degrees (or more), allowing removal of the spindle area tube 40.

In the description of the present invention, the invention will be discussed in a military environment; however, this invention can be utilized for any type of application that requires use of a tube removal and installation tool or any process that may require extended reach and turn applications.

In one of the preferred embodiments, the handle assembly 300 may be manufactured from aluminum, but any material that is practicable can be used. The handle assembly 300 may further have a diamond knurl cut for easy grip and twist, and may include a ninety (90) degree lock feature lockout relative to the head assembly 400 (shown in FIG. 5). The handle assembly 300 may include a handle assembly tooth like forward end that mates with a corresponding outer tube assembly tooth like forward end of the outer tube assembly 100, such that a ninety degree lock out feature is created.

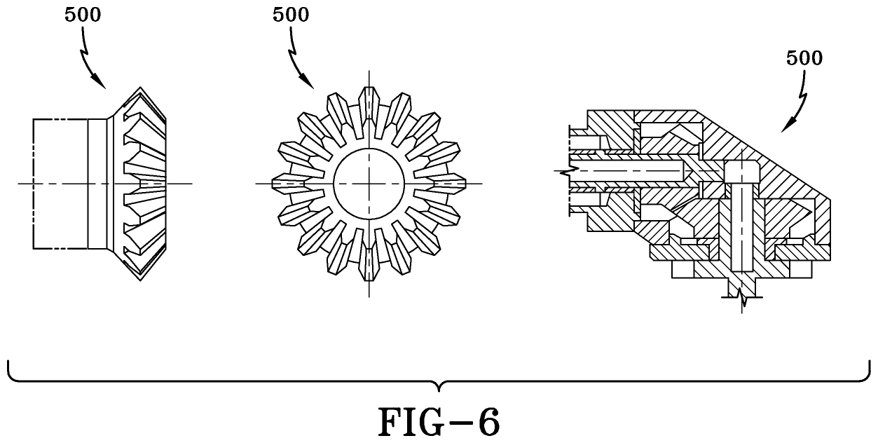

The outer tube assembly 100 may be, but without limitation, a seventy inch carbon fiber tube, which includes a grip to provide the user a way to manage the tool during use. The outer tube handle assembly 300 may also include bearing supports for the inner tube assembly 200 to rotate on and allow rotational movement. The outer tube assembly 100 may further also be, but without limitation, a seventy inch light weight, low flex, carbon fiber tube which includes a ten inch rubberized grip to provide comfort for the user and a way to manage the tool during use. The handle assembly 300 may include a front end and a back end, and may be, but without limitation, milled from aluminum to be ten inches in length with a diamond knurl cut to provide the user a solid surface to twist for tool operation. The handle assembly 300 may include a tooth type lock out where the handle assembly 300 is mated with the outer tube teeth at the front end in order to provide a lock the tool in a specific angle. The inner tube assembly 200 may be, but without limitation, constructed of light-weight, low flex carbon fiber or like material and ride on bearing supports inside the outer tube assembly 100 to provide the power to rotate the head of the tool to its desired position. The gear assembly 500, shown in FIG. 6, may be manufactured from steel and provide ninety (90) degree power transfer to the head assembly 400. The head assembly 400 may be manufactured from non-marring, black delrin, which may have a u-shaped channel three (3) inches long by one (1) inch wide with holes in the side for visual verification of placement.

When introducing elements of the present invention or the preferred embodiment(s) thereof, the articles “a,” “an,” “the,” and “said” are intended to mean there are one or more of the elements. The terms “comprising,” “including,” and “having” are intended to be inclusive and mean that there may be additional elements other than the listed elements.

Although the present invention has been described in considerable detail with reference to certain preferred embodiments thereof, other embodiments are possible. Therefore, the spirit and scope of the appended claims should not be limited to the description of the preferred embodiment(s) contained herein.

What is claimed is:

1. A spindle area tube removal and installation tool comprising:
an outer tube assembly;
an inner tube assembly disposed within the outer tube assembly, the inner tube assembly having a first end and a second end;
a handle assembly attached to the first end of inner tube assembly such that when the handle assembly is rotated the inner tube assembly rotates;
a head assembly for gripping clamps within the spindle area;
a gear assembly communicating with the head assembly, the gear assembly attached to the second end of the inner tube assembly such that when the inner tube assembly rotates the gear assembly provides a ninety degree power transfer to the head assembly, such that the head assembly rotates the clamps within the spindle area 360 degrees, allowing removal of the spindle area tube.
